(19) United States
(12) Patent Application Publication
(10) Pub. No.: US 2025/0102660 A1
(43) Pub. Date: Mar. 27, 2025

(54) SECURE RANGING SEQUENCE GENERATION

(71) Applicant: QUALCOMM INCORPORATED, San Diego, CA (US)

(72) Inventors: Varun Amar REDDY, San Diego, CA (US); Alexandros MANOLAKOS, Athens (GR)

(21) Appl. No.: 18/729,651

(22) PCT Filed: Mar. 7, 2023
(86) PCT No.: PCT/US2023/063846

§ 371 Date: Jul. 17, 2024

(30) Foreign Application Priority Data
Mar. 28, 2022 (GR) 20220100264

(51) Int. Cl. G01S 13/76; H04W 12/03; H04W 12/041; H04W 12/12; H04W 12/69; H04W 64/00

(52) U.S. Cl. CPC G01S 13/765; H04W 12/03; H04W 12/041; H04W 12/12; H04W 12/69; H04W 64/003

(57) ABSTRACT

A ranging method includes: receiving, at a first UE from a first entity, encryption input information; communicating, by the first UE with a second entity that is a second UE, to establish a ranging session with the second UE; using the encryption input information to produce an en-crypted ranging signal; and using the encrypted ranging signal in the ranging session for ranging between the first UE and the second UE.

### CROSS-REFERENCE TO RELATED APPLICATION

This application claims the benefit of Greek patent application Ser. No. 20220100264, filed on Mar. 28, 2022, entitled “SECURE RANGING SEQUENCE GENERATION,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example first UE (user equipment) includes: a transceiver configured to transmit and receive wireless signals; a memory; and a processor, communicatively coupled to the memory and the transceiver, configured to: receive, via the transceiver from a first entity, encryption input information; communicate, via the transceiver with a second entity that is a second UE, to establish a ranging session with the second UE; use the encryption input information to produce an encrypted ranging signal; and use the encrypted ranging signal in the ranging session for ranging between the first UE and the second UE.

An example ranging method includes: receiving, at a first UE from a first entity, encryption input information; communicating, by the first UE with a second entity that is a second UE, to establish a ranging session with the second UE; using the encryption input information to produce an encrypted ranging signal; and using the encrypted ranging signal in the ranging session for ranging between the first UE and the second UE.

Another example first UE includes: means for receiving, from a first entity, encryption input information; means for communicating, with a second entity that is a second UE, to establish a ranging session with the second UE; means for using the encryption input information to produce an encrypted ranging signal; and means for using the encrypted ranging signal in the ranging session for ranging between the first UE and the second UE.

An example non-transitory, processor-readable storage medium includes processor-readable instructions to cause a processor of a first UE to: receive, from a first entity, encryption input information; communicate, with a second entity that is a second UE, to establish a ranging session with the second UE; use the encryption input information to produce an encrypted ranging signal; and use the encrypted ranging signal in the ranging session for ranging between the first UE and the second UE.

An example apparatus includes: a transceiver configured to transmit and receive wireless signals; a memory; and a processor, communicatively coupled to the memory and the transceiver, configured to transmit, via the transceiver to at least a first UE and a second UE, an encryption message comprising encryption input information and a ranging indication indicating that the encryption input information is for producing an encrypted ranging signal for ranging.

An example ranging information distribution method includes: transmitting, from an apparatus to at least a first UE and a second UE, an encryption message comprising encryption input information; and transmitting, from the apparatus to at least the first UE and the second UE, a ranging indication indicating that the encryption input information is for producing an encrypted ranging signal for ranging.

Another example apparatus includes: means for transmitting, to at least a first UE and a second UE, an encryption message comprising encryption input information; and means for transmitting, to at least the first UE and the second UE, a ranging indication indicating that the encryption input information is for producing an encrypted ranging signal for ranging.

Another example non-transitory, processor-readable storage medium includes processor-readable instructions to cause a processor of an apparatus to: transmit, to at least a first UE and a second UE, an encryption message comprising encryption input information; and transmit, to at least the first UE and the second UE, a ranging indication indicating that the encryption input information is for producing an encrypted ranging signal for ranging.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5 is a block diagram of an example user equipment.

FIG. 6 is a block diagram of an example transmission/reception point.

FIG. 7 is a block diagram of an example environment for network-assisted positioning.

FIG. 8 is block diagram of a method of producing ciphertext for positioning.

FIG. 9 is a block diagram of an example environment for out-of-network-coverage positioning.

FIG. 10 is a block diagram of an example plaintext and an encryption key for use in a method of producing ciphertext for positioning.

FIG. 11 is a timing diagram of a signaling and process flow for reducing discovery overhead and secure ranging.

FIG. 12 is a block flow diagram of a ranging method.

FIG. 13 is a block flow diagram a ranging information distribution method.

### DETAILED DESCRIPTION

Techniques are discussed herein for generating secure ranging sequences for secure ranging (e.g., determining one or more ranges that may be used to determine position estimate of a device, and/or one or more position estimates of one or more devices). For example, an assistance data source (e.g., a transmission/reception point or a user equipment (UE)) may send assistance data to multiple user UEs. The assistance data may include some plaintext and an encryption key and/or information from which to determine an encryption key. The UEs receiving the assistance data may communicate with each other to determine further information, and may use the assistance data and the further information to complete a plaintext/encryption key combination and use the combination as inputs to an encryption process to produce ciphertext. The UEs may use the ciphertext to transmit, receive, and measure one or more ranging signals (that include the ciphertext). Other implementations than these examples, however, may be used.

Items and/or techniques described herein may provide one or more of the following capabilities, as well as other capabilities not mentioned. Overhead signaling for secure ranging may be reduced, compared to legacy approaches for secure ranging, by leveraging common data provided to multiple UEs to derive one or more secure ranging signals that is (are) transferred between the UEs and measured. Techniques discussed herein may scale to a large number of devices and facilitate low-overhead cooperative communication. Secure ranging may be performed by non-attacker devices in a cooperative environment in the presence of one or more attackers without being affected by the attacker(s). Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE (Institute of Electrical and Electronics Engineers) 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

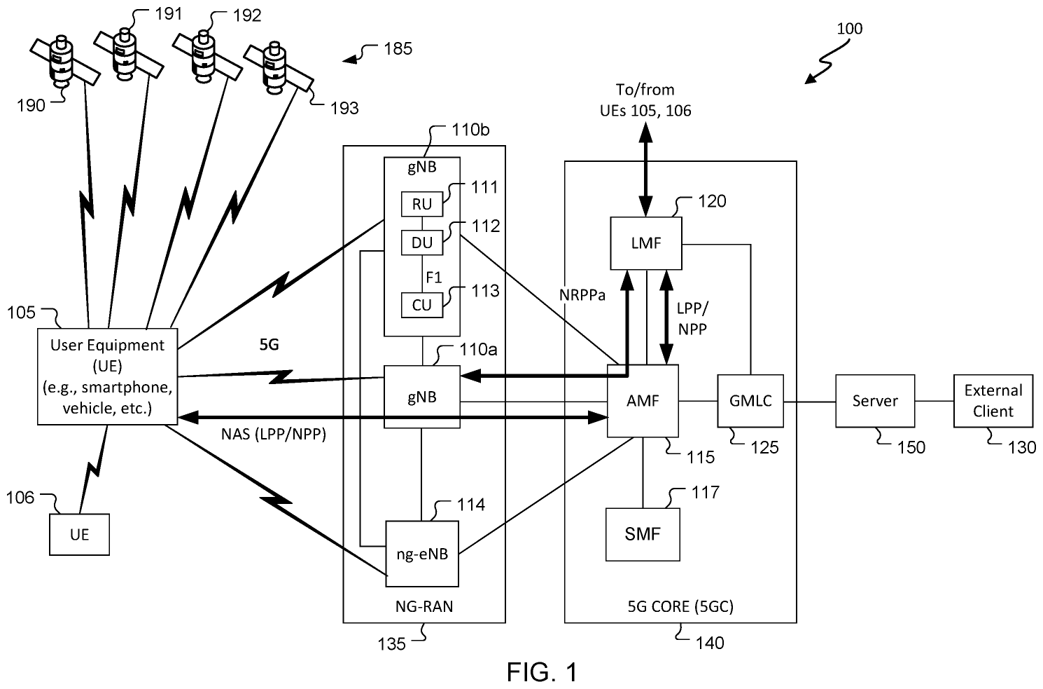

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3^{rd} Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi- directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth®-low energy (BLE), Zigbee, etc. One or more base stations, e.g., one or more of the gNBs 110a, 110b and/or the ng-eNB 114 may be configured to communicate with the UE 105 via multiple carriers. Each of the gNBs 110a, 110b and/or the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110a includes an RU 111, a DU 112, and a CU 113. The RU 111, DU 112, and CU 113 divide functionality of the gNB 110a. While the gNB 110a is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110a. The DU 112 hosts the Radio Link Control (RLC), Medium Access Control (MAC), and physical layers of the gNB 110a. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110a. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QoS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS (Synchronization Signals) or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

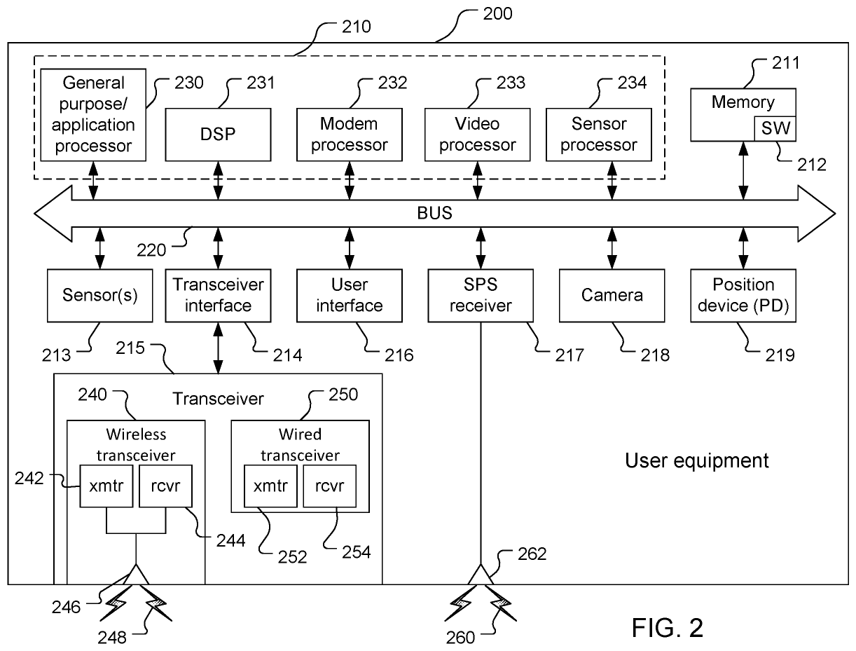

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6GHZ frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS (Complementary Metal-Oxide Semiconductor) imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

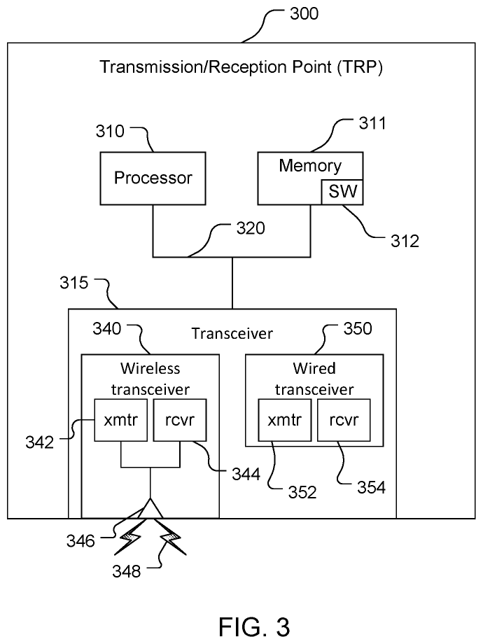

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

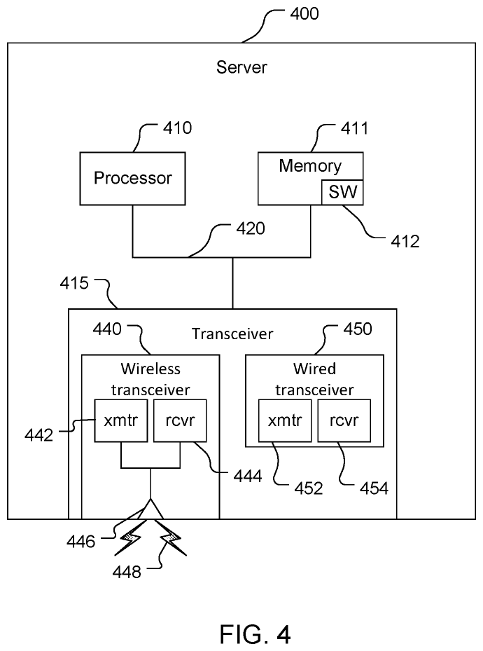

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below.

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records’, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference T_{Rx→Tx} (i.e., UE T_{Rx-Tx} or UE_{Rx-Tx}) between the ToA of the RTT measurement signal and the transmission time of the RTT response message in a payload of each RTT response message. The RTT response message would include a reference signal from which the base station can deduce the ToA of the RTT response. By comparing the difference T_{Tx→Rx} between the transmission time of the RTT measurement signal from the base station and the ToA of the RTT response at the base station to the UE-reported time difference T_{Rx→Tx}, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS (Channel State Information—Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer, DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every N^{th} resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (Base Transceiver Station) (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning being sent by UEs, and with PRS and SRS for positioning being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

### Peer-to-Peer Ranging

Various signal sequences may be used for ranging between devices, e.g., peer devices such as UEs (user equipments). Channel estimation sequences may be transferred between devices and measured to determine a channel estimation. For example, a SYNC and/or an STS (secure time sequence) may be used for channel estimation, with the SYNC used for acquisition, preamble detection, and time and frequency synchronization, and the STS providing security enhancements relative to the SYNC, and thus used for channel estimation when security and integrity are desired. Preamble sequences such as Ipatov sequences have desirable autocorrelation properties that enable simpler channel estimation and more accurate position estimation. A transmitter sends a preamble sequence and a receiver, knowing what sequence to expect, performs correlation on the received signal using the known sequence to determine a channel estimation. Preamble sequences such as the Ipatov sequence are publicly known and thus susceptible to over-the-air (OTA) attacks, where an attack can manipulate the estimation process of a receiver. Security attacks, e.g., for positioning, can take a variety of forms including an across-symbol attack where an attacker receives one or more PRS symbols, determines transmission parameters, and generates a new signal for a subsequent PRS. Another attack is an inside-job attack where a disguised attacker receives a full PRS configuration (e.g., through broadcast assistance data (AD) or unicast RRC) and generates and transmits PRS to a receiver. Another attack is a within-symbol attack where an attacker observes a first part of a single OFDM symbol, detects the transmitted QAM (quadrature amplitude modulation) symbols, and generates and transmits a second part of the OFDM symbol. The use of encryption such as AES (Advanced Encryption Standard) encryption has been proposed for achieving physical-layer (PHY-layer) security for secure ranging. Information can be transferred over a secure link (using AES encryption) so that only the transmitter and receiver will know the preamble sequence, providing more secure channel estimation although perhaps with less correlation accuracy. In large-scale cooperative positioning scenarios (e.g., public safety, IoT (Internet of Things)) and sidelink, several UEs would desirably perform relative ranging with one another in a secure manner, by exchanging sequence information. Techniques are discussed herein for distribution of information to support secure measurements.

An STS may be generated using a Deterministic Random Bit Generator (DRBG). For example, a DRBG may use a 96-bit plaintext portion in combination with a 32-bit counter to form a 128-bit plaintext. The 128-bit plaintext and a 128-bit encryption key may be used as inputs to an AES-128 encryption algorithm that produces a 128-bit pseudo random number, based on the inputs, that may be used as the STS.

Rather than generate and exchange a new encryption key, two communicating devices may implicitly perform key derivation (also called key rotation) to generate a new encryption key. Given a common data field (i.e., a data field shared by (known to) P, each of the devices) and a random salt (a random number), a derived encryption key may be obtained according to

$$Derived key = KDF ( P , salt )$$

where KDF is a key derivation function, P is the common data field, and salt is the random salt. The random salt may be derived from information known privately to the transmitter and receiver devices (e.g., a session ID, a MAC address, etc.). KDF provides a secure technique for generating a new key and is performed by both the transmitter and receiver devices so that the new key is known to both devices. Using key derivation provides security against brute force attacks, which may be bolstered further using an iteration value. Key derivation functions are performed intermittently (e.g., periodically) in key rotation to help prevent attackers from predicting/cracking the sequence. Examples of publicly-known KDFs include PBKDF2, Bcrypt, Scrypt, and Argon2.

Different techniques may be used by UEs for discovery and ranging session set up. For example, an announcing UE may broadcast an announcement message and one or more monitoring UEs may receive the message. This discovery technique is referred to as Model A in LTE. As another example, a discoverer UE may send a solicitation message containing a discovery request and one or more discoveree UEs may receive the discovery request and send a response message. This discovery technique is referred to as Model B in LTE. A ranging session may be conducted using one or more of a variety of signaling technologies, e.g., NR, UWB (Ultra-Wideband), WiFi, etc. Ranging session set up may be performed using broadcast, groupcast, or unicast messaging. For example, for NR release 16, Option 1 is a groupcast sidelink set up using NACK-only HARQ (Negative Acknowledgement Hybrid Automatic Repeat Request) feedback and Option 2 is groupcast with ACK (Acknowledge) or NACK HARQ feedback. Information may be agreed to between UEs, e.g., being transmitted by one UE to another for unilateral agreement, or by mutual agreement of information transferred from one UE to another or otherwise known by both UEs.

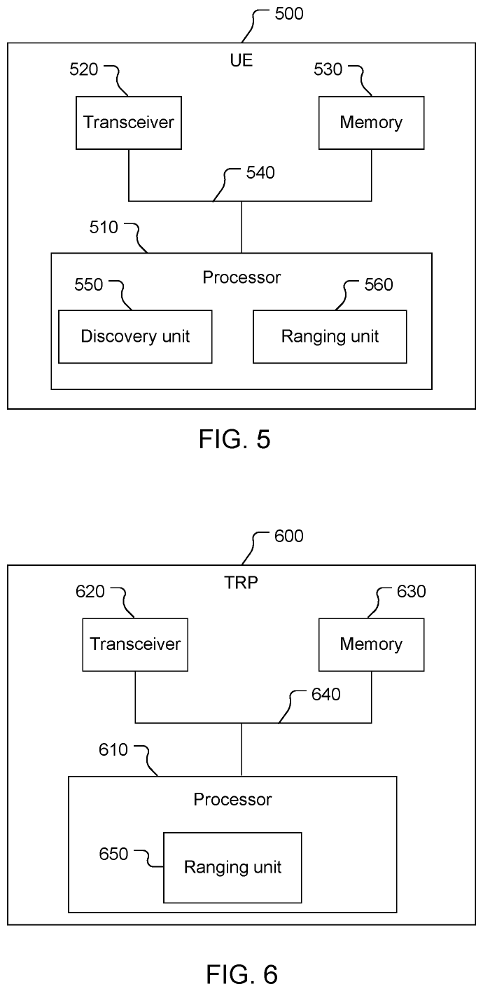

Referring also to FIG. 5, a UE 500 includes a processor 510, a transceiver 520, and a memory 530 communicatively coupled to each other by a bus 540. The UE 500 may include the components shown in FIG. 5. The UE 500 is a wireless communication device and is part of a monitor vehicle (e.g., car, truck, motorcycle, etc.) that is capable of monitoring another vehicle (e.g., analyzing one or more images of a target vehicle to determine and report one or more characteristics of the target vehicle, and/or receiving and reporting one or more messages from another monitor vehicle regarding the target vehicle, etc.). The UE 500 may include one or more other components such as any of those shown in FIG. 2 such that the UE 200 may be an example of the UE 500. For example, the processor 510 may include one or more of the components of the processor 210. The transceiver 520 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 520 may include the wired transmitter 252 and/or the wired receiver 254. The memory 530 may be configured similarly to the memory 211, e.g., including software with processor-readable instructions configured to cause the processor 510 to perform functions.

The description herein may refer to the processor 510 performing a function, but this includes other implementations such as where the processor 510 executes software (stored in the memory 530) and/or firmware. The description herein may refer to the UE 500 performing a function as shorthand for one or more appropriate components (e.g., the processor 510 and the memory 530) of the UE 500 performing the function. The processor 510 (possibly in conjunction with the memory 530 and, as appropriate, the transceiver 520) may include a discovery unit 550 and a ranging unit 560. The discovery unit 550 and the ranging unit 560 are discussed further below, and the description may refer to the processor 510 generally, or the UE 500 generally, as performing any of the functions of the discovery unit 550 or the ranging unit 560, with the UE 500 being configured to perform the functions of the discovery unit 550 and the ranging unit 560.

Referring also to FIG. 6, a TRP 600 includes a processor 610, a transceiver 620, and a memory 630 communicatively coupled to each other by a bus 640. The TRP 600 may include the components shown in FIG. 6. The TRP 600 may include one or more other components such as any of those shown in FIG. 3 such that the TRP 300 may be an example of the TRP 600. For example, the processor 610 may include one or more of the components of the processor 310, the transceiver 620 may include one or more of the components of the transceiver 315, and/or the memory 630 may be configured similarly to the memory 311, e.g., including software with processor-readable instructions configured to cause the processor 610 to perform functions.

The description herein may refer to the processor 610 performing a function, but this includes other implementations such as where the processor 610 executes software (stored in the memory 630) and/or firmware. The description herein may refer to the TRP 600 performing a function as shorthand for one or more appropriate components (e.g., the processor 610 and the memory 630) of the TRP 600 performing the function. The processor 610 (possibly in conjunction with the memory 630 and, as appropriate, the transceiver 620) includes a ranging unit 650. The ranging unit 650 is discussed further below, and the description may refer to the processor 610 generally, or the TRP 600 generally, as performing any of the functions of the ranging unit 650. The TRP 600 is configured to perform the functions of the v ranging unit 650.

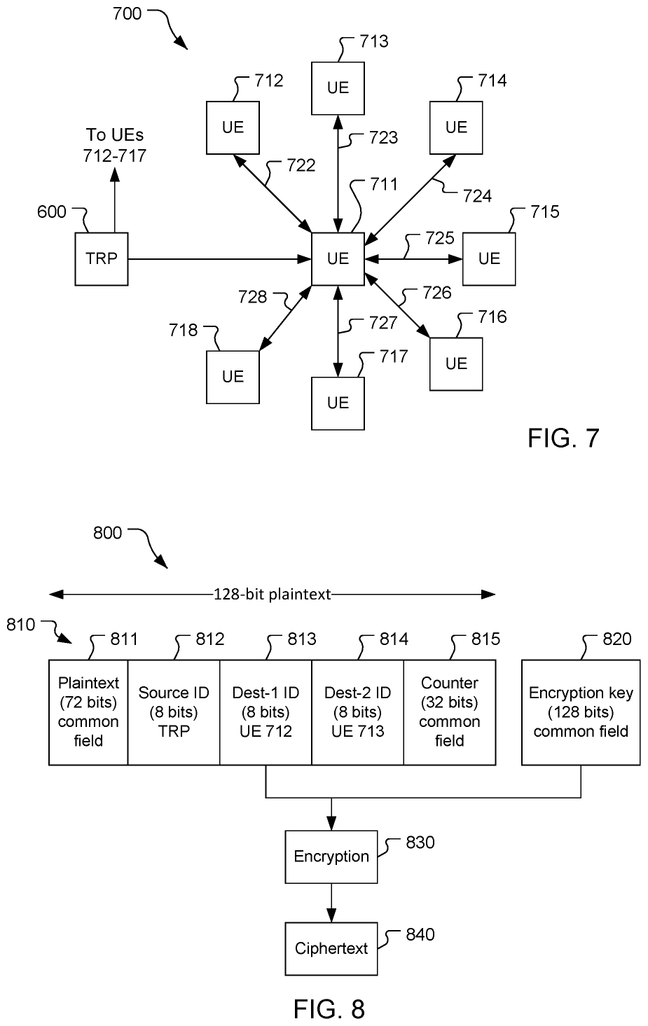

Referring also to FIG. 7, an environment 700 for network-assisted positioning (e.g., using ranging sessions) includes the TRP 600 and UEs 711, 712, 713, 714, 715, 716, 717, 718. In the environment 700, each of the UEs 711-718 is within network coverage, i.e., within communication range of a network entity, here the TRP 600. The UEs 711-718 may be a cooperative positioning network, with the UEs 711-718 able to work with each other to perform ranging to determine one or more position estimates for one or more of the UEs 711-718. For example, the UEs 711-718 may perform pairwise positioning and there may be a link between each of the UEs 711-718 (resulting in a total of 28 links), although only links 722, 723, 724, 725, 726, 727, 728 between the UE 711 and the UEs 712-718, respectively, are shown in FIG. 7. If each pairwise link is set up separately, a significant amount of overhead is involved in generating and negotiating a secure sequence for each of the pairwise links. Pairs of the UEs 711-718 may engage in discovery, transmitting and receiving information to establish a connection and possibly transmitting and/or receiving information, and possibly agreeing to information, for ranging.

To reduce the overhead involved in generating and negotiating a secure sequence for each of the pairwise links, the TRP 600 may transmit, e.g., broadcast, network assistance data to the UEs 711-718. This may avoid or reduce information being transferred between each pair of the UEs 711-718 to establish information for secure positioning. For example, UE pairs may avoid transmitting the full information for encryption key generation. The network assistance data may include common seed information for all of the UEs 711-718. The UEs 711-718 may use the common seed information to generate secure sequences for each of the pairwise links in a scalable manner. For example, each pair of the UEs 711-718 may use one portion of the seed information as common data, or a portion of the common data, and use another portion of the seed information in a key derivation function to construct a common key, and use a combination of the common data and the common key in an encryption function (e.g., algorithm) to generate secure ranging information (a secure sequence) for channel estimation. This avoids exchanging and negotiating the data/key combination for each link between the appropriate UEs 711-718, thus reducing overhead and processing power to establish the secure ranging information and using the secure ranging information to perform channel estimation. Both UEs in a pair (the Tx UE and the Rx UE) individually generate the secure sequence for channel estimation that can be used for ranging and thus for secure positioning.

Referring also to FIG. 8, method 800 of producing ciphertext for positioning to generate a secure sequence is shown. The method 800 uses plaintext and an encryption key as inputs to an encryption process 830 to change plaintext into ciphertext. The entire plaintext and the encryption key may be transmitted by the TRP 600 as the seed information. As another example, the seed information may include some of the plaintext and the encryption key, as with the example shown in FIG. 8. As shown in FIG. 8, an example plaintext 810 includes a plaintext portion 811, a source ID 812, first destination ID 813, a second destination ID 814, and a counter 815. In this example, the example plaintext 810 is 128 bits and the plaintext portion 811 is 72 bits, the source ID 812 is 8 bits, the first destination ID 813 is 8 bits, the second destination ID 814 is 8 bits, and the counter 815 is 32 bits. The counter 815 may be incremented to establish a new value of the plaintext 810. The plaintext portion 811 and the counter 815 (at least the initial value of the counter 815) may be common fields, being included in the network assistance data broadcast by the TRP 600 and thus common data (the same data) for all of the UEs 711-718. The source ID 812 may also be included in the network assistance data and therefore also common to (the same for) all of the UE pairings. The first destination ID 813 and the second destination ID 814 are the IDs for the UEs in each of the pairs of the UEs 711-718 and are thus dependent on the particular pair in question, although other information could be used/agreed to (e.g., other than UE IDs). In this example, the first destination ID 813 is an ID for the UE 712 and the second destination ID 814 is an ID for the UE 713. An encryption key 820 may be obtained, e.g., retrieved from memory or provided in the network assistance data and thus be a common field (the same data) for each of the pairs of the UEs 711-718. The ranging unit 560 of each of the UEs may use the example plaintext 810 and the encryption key 820 (or key derived therefrom as discussed below) as inputs to an encryption process 830 to produce ciphertext 840 for the respective pair of the UEs 711-718, here the UEs 712, 713, to be used as the STS for secure ranging. The encryption key 820 may be the same for different pairs of the UEs 711-718 or different UE pairs may use different encryption keys. To establish the ciphertext, perhaps only the destination IDs 813, 814 are transmitted between the UEs 712, 713, thus dramatically reducing the overhead to produce the ciphertext compared to transmitting complete plaintext and a complete encryption key for use in the encryption process 830.

The plaintext 810 and/or the encryption key 820 may be varied over time. For example, the TRP 600 (e.g., the ranging unit 650) may transmit the network assistance data periodically, with the network assistance data varying with each transmission. The plaintext portion 811 may be different between different transmissions of the network AD. As another example, the discovery units 550 the UEs in a pair, in this example the UEs 712, 713, may agree to some or all of the common data during a discovery phase, e.g., through secure unicast transmissions. The discovery units 550 may, for example, agree to replace one or more bits of the plaintext portion 811 with one or more agreed-to bits.

For additional security, encryption keys may be determined by each pair of the UEs 711-718 such that different encryption keys may be used for different pairs of the UEs 711-718. For example, a KDF may be applied to the encryption key 820 of each pair of the UEs 711-718 to determine a revised encryption key to be used as an input to the encryption process 830. For example, each pair of the UEs 711-718 (e.g., the discovery unit 550 of each UE of each pair of the UEs 711-718) may derive a key using the encryption key 820 as an input to a key derivation function. The discovery units 550 may agree upon, e.g., during unicast communications during discovery, one or more KDF parameters such as a random salt value, a key distribution function to use, etc. The key derived using the KDF and the agreed-upon KDF parameter(s) may be different for each pair of the UEs 711-718.

Also or alternatively, for additional security, the TRP 600 may provide a proprietary key generation strategy to one or more pairs of the UEs 711-718. For example, the TRP 600 may indicate a proprietary key derivation function for a pair of the UEs 711-718 to use. As another example, the TRP 600 may indicate a strategy to determine an encryption key (e.g., may provide a proprietary strategy for a pair of the UEs 711-718 to determine an encryption key independently of the encryption key 820 (in which case the TRP 600 may not transmit the encryption key 820)).

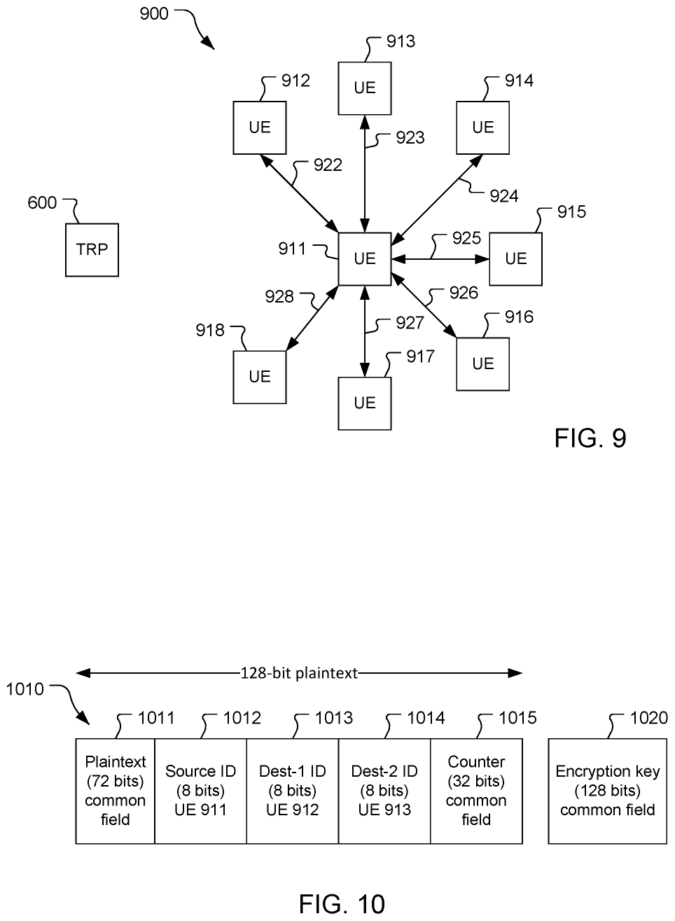

Referring also to FIG. 9, an environment 900 for out-of-network-coverage positioning includes UEs 911, 912, 913, 914, 915, 916, 917, 918. In the environment 900, none of the UEs 911-918 is within network coverage, i.e., within communication range of a network entity, such as the TRP 600. The UEs 911-918 may be a cooperative positioning network, with the UEs 911-918 able to work with each other to perform ranging to determine one or more position estimates for one or more of the UEs 911-918. For example, the UEs 911-918 may perform pairwise positioning and there may be a link between each of the UEs 911-918 (resulting in a total of 28 links), although only links 922, 923, 924, 925, 926, 927, 928 between the UE 911 and the UEs 912-918, respectively, are shown in FIG. 9. If each pairwise link is set up separately, a significant amount of overhead is involved in generating and negotiating a secure sequence for each of the pairwise links. Pairs of the UEs 911-918 may engage in discovery, transmitting and receiving information to establish a connection and possibly transmitting and/or receiving information, and possibly agreeing to information, for ranging.

To reduce the overhead involved in generating and negotiating a secure sequence for each of the pairwise links, the UE 911 may transmit, e.g., broadcast, groupcast, and/or unicast assistance data to the UEs 912-918. This may avoid or reduce information being transferred between each pair of the UEs 912-718 to establish information for secure positioning. For example, UE pairs may avoid transmitting the full information for encryption key generation. The assistance data may include common seed information for all of the UEs 912-918. The UEs 912-918 may use the common seed information to generate secure sequences for each of the pairwise links in a scalable manner. For example, each pair of the UEs 912-918 may use one portion of the seed information as common data, or a portion of the common data, and use another portion of the seed information in a key derivation function to construct a common key, and use a combination of the common data and the common key in an encryption function (e.g., algorithm) to generate secure ranging information (a secure sequence) for channel estimation. This avoids exchanging and negotiating the data/key combination for each link between the appropriate UEs 912-918, thus reducing overhead and processing power to establish the secure ranging information and using the secure ranging information to perform channel estimation. Both UEs in a pair (the Tx UE and the Rx UE) individually generate the secure sequence for channel estimation that can be used for ranging and thus for secure positioning. For example, if the UE 911 has communicated with the UE 912 and the UE 913, and has informed each of the UEs 912, 913 of communication with the other UE 912, 913, and the UEs 912, 913 want to initiate a ranging session with each other, then the UEs 912, 913 may use information from the UE 911 to reduce overhead and conserve time and/or energy resources to establish a secure ranging session.

Similar to the discussion above with respect to FIG. 8, an encryption process implemented by pairs of the UEs 912-918 uses plaintext and an encryption key as inputs to an encryption process to change plaintext into ciphertext. The entire plaintext and the encryption key may be transmitted by the UE 911 as the seed information. As another example, referring also to FIG. 10, the seed information may include some of the plaintext and the encryption key. As shown in FIG. 10, an example plaintext 1010 includes a plaintext portion 1011, a source ID 1012, first destination ID 1013, a second destination ID 1014, and a counter 1015. In this example, the example plaintext 1010 is 128 bits and the plaintext portion 1011 is 72 bits, the source ID portion 1012 is 8 bits, the first destination ID 1013 is 8 bits, the second destination ID 1014 is 8 bits, and the counter 1015 is 32 bits. The counter 1015 may be incremented to establish a new value of the example plaintext 1010. The plaintext portion 1011 and the counter 1015 (at least the initial value of the counter 1015) may be common fields, being included in the assistance data transmitted by the UE 911 and thus common data (the same data) for all of the UEs 912-918, or at least the pair of UEs 912, 913. The source ID 1012 may also be included in the assistance data and therefore also common to (the same for) all of the UE pairings. The first destination ID 1013 and the second destination ID 1014 are the IDs for the UEs in each of the pairs of the UEs 911-918 and are thus dependent on the particular pair in question. In this example, the first destination ID 1013 is an ID for the UE 912 and the second destination ID 1014 is an ID for the UE 913. An encryption key 1020 may be obtained, e.g., retrieved from memory or provided in the assistance data and thus be a common field (the same data) for each of the pairs of the UEs 911-918, or at least each respective pair of UEs. The ranging unit 560 of each of the UEs may use the example plaintext 1010 and the encryption key 1020 (or key derived therefrom as discussed below) as inputs to an encryption process to produce ciphertext for the respective pair of the UEs 911-918, here the UEs 912, 913, to be used as the STS for secure ranging. The encryption key 1020 may be the same for different pairs of the UEs 911-918 or different UE pairs may use different encryption keys. To establish the ciphertext, perhaps only the destination IDs 1013, 1014 are transmitted between the UEs 1012, 1013, thus dramatically reducing the overhead to produce the ciphertext compared to transmitting complete plaintext and a complete encryption key for use in the encryption process.

Similar to the discussion above, the example plaintext 1010 and/or the encryption key 1020 may be varied over time, and/or additional security may be provided. For example, the UE 911 (e.g., the ranging unit 650) may transmit the assistance data periodically, with the assistance data varying with each transmission. For additional security, encryption keys may be determined by each pair of the UEs 912-918 such that different encryption keys may be used for different pairs of the UEs 912-918. For example, a KDF may be applied to the encryption key 1020 of each pair of the UEs 912-918 to determine a revised encryption key to be used as an input to the encryption process (e.g., with the pair of UEs establishing one or more KDF parameters during unicast discovery). Also or alternatively, for additional security, the UE 911 may provide a proprietary key generation strategy to one or more pairs of the UEs 912-918. For example, the UE 911 may indicate a proprietary key derivation function for a pair of the UEs 912-718 to use. As another example, the UE 911 may indicate a strategy to determine an encryption key (e.g., may provide a proprietary strategy for a pair of the UEs 912-918 to determine an encryption key independently of the encryption key 1020 (in which case the UE 911 may not transmit the encryption key 1020)).

Using the KDF to generate a key provides extra security. For example, if one or more of the UEs 911-918 is an attacker, two non-attacker UEs may agree on one or more KDF values (e.g., one or more input values such the random salt, an ID, or one or more parameters affecting operation) using secure unicast communication and generate a unique based on the agreed-upon KDF value(s). Being hidden from other UEs, using such value(s) provides ranging that is robust to security attacks. An attacker would be limited to attacking links involving the attacker and links between non-attackers would be immune to the attacker.

Techniques discussed herein have applicability beyond ranging. For example, the UEs 912, 913, having interacted with the UE 911, have been provided with some discovery-phase information. Some redundancy of obtaining this discovery-phase information may be eliminated for discovery between the UEs 912, 913. The same may be true in the network-coverage scenario, with the UEs 712, 713 receiving information in the network assistance data from the TRP 600. Eliminating the redundancy may speed up the discovery process and setup, and/or may conserve time and/or energy resources.

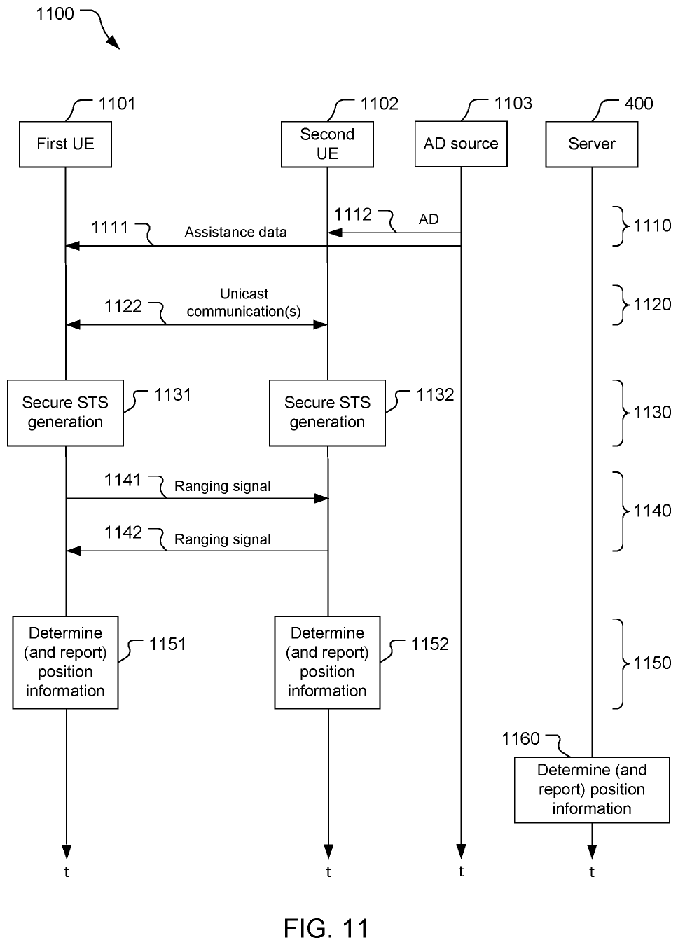

Referring to FIG. 11, with further reference to FIGS. 1-10, a timing diagram shows a signaling and process flow 1100 for reducing discovery overhead and secure ranging includes the stages shown. Other flows are possible, e.g., with one or more stages shown omitted, one or more stages added, and/or one or more stages shown altered. For example, stages 1130, 1140, 1150 may be omitted and replaced with other stages, e.g., for general communication.

At stage 1110, an AD source 1103 (assistance data source) transmits assistance data 1111 to a first UE 1101 and transmits assistance data 1112 to a second UE 1102. The UEs 1101, 1102 may be examples of the UE 500, e.g., the UEs 712, 713 or the UEs 912, 913. The AD source 1103 may be a network entity such as the TRP 600 or another UE, e.g., the UE 911. The assistance data 1111, 1112 may be a broadcast message, a groupcast message, or separate unicast messages, or parts of any thereof. The assistance data 1111, 1112 may include common data as discussed above. If the assistance data 1111, 1112 are unicast messages, then the assistance data 1111 may indicate that the AD source 1103 communicated with the second UE 1102 (to provide/agree to the assistance data 1111) and the assistance data 1112 may indicate that the AD source 1103 communicated with the first UE 1101 (to provide/agree to the assistance data 1112)

At stage 1120, the first UE 1101 and the second UE 1102 engage in discovery. The UEs 1101, 1102 (e.g., the discovery units 550 of the UEs 1101, 1102) transmit one or more unicast communications 1122 to discover each other. As part of the unicast discovery process, the UEs 1101, 1102 may agree to common data and unique data as part of a plaintext/encryption key combination, e.g., as shown in and discussed with respect to FIGS. 8 and 10. The UEs 1101, 1102 may agree to information by having one of the UEs 1101, 1102 transmit the information to the other of the UEs 1101, 1102 even if no explicit agreement (e.g., acknowledgement) by the receiving UE of the UEs 1101, 1102 is provided (e.g., sent to the transmitting UE). Information received at stage 1110 is leveraged at stage 1120 such that less information may be passed at stage 1120 than had stage 1110 not be performed.

At stage 1130, a secure STS is generated by both of the UEs 1101, 1102. At sub-stages 1131, 1132, the ranging units 560 of the UEs 1101, 1102 may generate new encryption keys based on information received/agreed to at stage 1120, e.g., according to a KDF and information received/agreed to at stage 1120 or otherwise obtained (e.g., retrieved from memory). The ranging units 560 of the UEs 1101, 1102 generate the same STS from the same plaintext and encryption key, e.g., using an encryption key obtained at stage 1120, or otherwise obtained (e.g., generated using the KDF). The obtained STS is known only to the UEs 1101, 1102 and thus provides for secure ranging between the UEs 1101, 1102.

At stage 1140, the UEs 1101, 1102 conduct a ranging session. The first UE 1101 may transmit a ranging signal 1141, e.g., a UWB (ultra-wideband) ranging signal including the generated STS, to the second UE 1102 and/or the second UE 1102 may transmit a ranging signal 1142 to the first UE 1101. The ranging signals 1141, 1142 may change over time, e.g., by varying the plaintext and/or the encryption key and regenerating the STS.

At stage 1150, the UEs 1101, 1102 may determine, and possibly report, position information. For example, at sub-stage 1152 the ranging unit 560 of the second UE 1102 may measure the received ranging signal 1141 and/or at sub-stage 1151 the ranging unit 560 of the first UE 1101 may measure the received ranging signal 1142, e.g., to determine position information (e.g., ToA, AoA, etc.). Either or both of the UEs 1101, 1102 may report some or all of the determined position information, e.g., to the other of the UEs 1101, 1102 and/or to the server 400 and/or other network entity. Either of the UEs 1101, 1102 may use the position information received from the other UE 1101, 1102 to determine, and possibly report, further position information (e.g., range to the other UE 1101, 1102, position estimate for one or more of the UEs 1101, 1102, etc.).

At stage 1160, the server 400 determines position information. The server 400 may determine position information from position information (e.g., one or more raw measurements and/or one or more processed measurements (e.g., range(s)) reported by one or more of the UEs 1101, 1102. For example, the server 400 may determine a range between the UEs 1101, 1102 and/or a position estimate for the first UE 1101 and/or a position estimate for the second UE 1102. The server 400 may report position information to one or more of the UEs 1101, 1102 (e.g., position information not provided by the respective UE 1101, 1102).

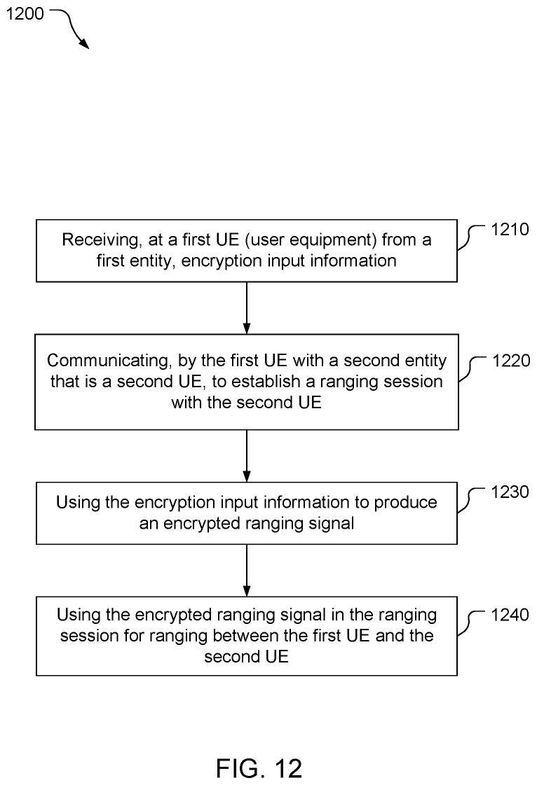

Referring to FIG. 12, with further reference to FIGS. 1-11, a ranging method 1200 includes the stages shown. The method 1200 is, however, an example and not limiting. The method 1200 may be altered, e.g., by having stages added, removed, rearranged, combined, performed concurrently, and/or having single stages split into multiple stages.

At stage 1210, the method 1200 includes receiving, at a first UE from a first entity, encryption input information. For example, the first UE 1101 may receive the AD 1111 from the AD source 1103, e.g., the UE 711 (and/or any of the UEs 712-718) may receive network AD from the TRP 600 or the UE 912 (and/or any of the UEs 913-918) may receive AD from the UE 911. The network AD from the TRP 600 or the AD from the UE 911 may include plaintext (or a portion thereof) and an encryption key (or information for determining the encryption key, e.g., KDF information). The processor 510, possibly in combination with the memory 530, in combination with the transceiver 520 (e.g., the wireless receiver 244 and the antenna 246) may comprise means for receiving the encryption input information.

At stage 1220, the method 1200 includes communicating, by the first UE with a second entity that is a second UE, to establish a ranging session with the second UE. For example, at stage 1120, the discovery unit 550 of the first UE 1101 transmits and/or receives the one or more unicast communications 1122 to/from the second UE 1102 to establish a ranging session between the UEs 1101, 1102. The processor 510, possibly in combination with the memory 530, possibly in combination with the transceiver 520 (e.g., the wireless transmitter 242 and the antenna 246 and/or the wireless receiver 244 and the antenna 246) may comprise means for communicating to establish a ranging session with the second UE.

At stage 1230, the method 1200 includes using the encryption input information to produce an encrypted ranging signal. For example, at stage 1131 the ranging unit 560 of the UE 1101 uses information from the AD 1111 to produce the STS (e.g., from the plaintext (some of which may be from the AD 1111 and some of which may be agreed to by the UEs 1101, 1102) and the encryption key (provided or derived)). The processor 510, possibly in combination with the memory 530, may comprise means for using the encryption input information to produce the encrypted ranging signal.

At stage 1240, the method 1200 includes using the encrypted ranging signal in the ranging session for ranging between the first UE and the second UE. For example, at stage 1140, the first UE 1101 may send the ranging signal 1141 to the second UE 1102 and/or the second UE 1102 may send the ranging signal 1142 to the first UE 1101. As another example, at sub-stage 1151, the first UE 1101 may determine, and possibly report, position information based on transmission of the ranging signal 1141 and/or reception and measurement of the ranging signal 1142. The processor 510, possibly in combination with the memory 530, possibly in combination with the transceiver 520 (e.g., the wireless transmitter 242 and the antenna 246 and/or the wireless receiver 244 and the antenna 246) may comprise means for using the encrypted ranging signal in the ranging session for ranging between the first UE and the second UE.

Implementations of the method 1200 may include one or more of the following features. In an example implementation, the encryption input information is first encryption input information, and wherein the ranging method 1200 further includes: communicating by the first UE with the second UE to agree to second encryption input information; and using, at the first UE, the first encryption input information and the second encryption input information to produce the encrypted ranging signal. For example, the first encryption input information may include the plaintext portion 811 (or a portion thereof), the counter 815, and the encryption key 820, and the first UE 1101 may agree with the second UE 1102 regarding second encryption input information such as a portion of the plaintext portion 811, the source ID 812, the first destination ID 813, and/or the second destination ID 814. The discovery units 550 of the UEs 1101, 1102 may communicate to agree to the second encryption input information (e.g., portion of plaintext, ID(s), and/or other information unique to the ranging session). The ranging unit 560 of the first UE 1101 may use the first and second encryption input information to produce the encrypted ranging signal, e.g., using the example plaintext 810 and the encryption key 820 as inputs to the encryption process 830 to produce the ciphertext 840. The processor 510, possibly in combination with the memory 530, possibly in combination with the transceiver 520 (e.g., the wireless transmitter 242 and the antenna 246 and/or the wireless receiver 244 and the antenna 246) may comprise means for communicating with the second UE to agree to the second encryption input information and the processor 510, possibly in combination with the memory 530, may comprise means for using the first and second encryption input information to produce the encrypted ranging signal. In a further example implementation, the second encryption input information includes a first identity associated with the first entity, or a second identity associated with the second entity, or a third identity associated with the first UE, or any combination thereof. For example, the agreed-to encryption input information includes the source ID 812, the first destination ID 813, and/or the second destination ID 814. In another further example implementation, at least some of the second encryption input information replaces at least some of the first encryption input information. For example, the UEs 1101, 1102 may receive the example plaintext portion 811 and agree to replace some or all of the example plaintext portion 811 with other information. In another further example implementation, the second encryption input information includes at least one key derivation function parameter, and the ranging method 1200 further includes using the at least one key derivation function parameter as part of a key derivation function to produce the encrypted ranging signal. For example, the UEs 1101, 1102 may agree to KDF information (e.g., a seed value, a random salt, a KDF parameter affecting operation (e.g., a selected KDF function), etc.), and use the KDF information in and/or to select a KDF to produce the encrypted ranging signal, e.g., by deriving an encryption key that is used in the encryption process 830 to produce the ciphertext 840. In a further example implementation, the at least one key derivation function parameter comprises a random salt, or an indication of a proprietary key derivation function, or a combination thereof.

Also or alternatively, implementations of the method 1200 may include one or more of the following features. In an example implementation, the method 1200 further includes receiving, at the first UE, the encryption input information from a transmission/reception point in a broadcast message. For example, the UE 1101 (e.g., the UE 711) receives network AD as the AD 1111, with the AD source 1103 being the TRP 600. In another example implementation, the method 1200 includes receiving, at the first UE, the encryption input information from a third UE in a positioning assistance message, and at least one of: producing the encrypted ranging signal based on the positioning assistance message identifying the second UE; or using the encrypted ranging signal in the ranging session based on the positioning assistance message identifying the second UE; or a combination thereof. For example, the UE 1101 (e.g., the UE 912) receives the AD 1111, with the AD source 1103 being the UE 911, and produces the STS based on the AD identifying the second UE 1102 (e.g., leverages information from the AD 1111 to produce the STS for the ranging session with the second UE 1102) and/or uses the STS (e.g., provided to the UE 1101) for ranging in the ranging session with the second UE 1102 (e.g., transmitting the STS to the second UE 1102 and/or receiving and measuring the STS from the second UE 1102). The processor 510, possibly in combination with the memory 530, may comprise means for producing the encrypting ranging signal based on the positioning assistance message identifying the second UE. The processor 510, possibly in combination with the memory 530, possibly in combination with the transceiver 520 (e.g., the wireless transmitter 242 and the antenna 246 and/or the wireless receiver 244 and the antenna 246) may comprise means for using the encrypted ranging signal in the ranging session.

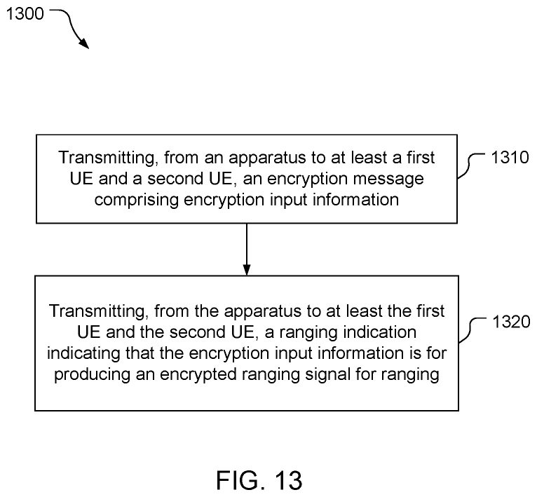

Referring to FIG. 13, with further reference to FIGS. 1-11, a ranging information distribution method 1300 includes the stages shown. The method 1300 is, however, an example and not limiting. The method 1300 may be altered, e.g., by having stages added, removed, rearranged, combined, performed concurrently, and/or having single stages split into multiple stages.

At stage 1310, the method 1300 includes transmitting, from an apparatus to at least a first UE and a second UE, an encryption message comprising encryption input information. For example, the TRP 600 may be the AD source 1103 and broadcast network AD as the AD 1111, 1112 to the UEs 1101, 1102, with the AD 1111, 1112 including at least a portion of the example plaintext 810 and/or at least a portion of the encryption key 820 (or information for deriving the encryption key 820). As another example, the UE 911 may be the AD source 1103 and broadcast, groupcast, or unicast the AD 1111, 1112 to the UEs 1101, 1102, with the AD 1111, 1112 including at least a portion of the example plaintext 1010 and/or at least a portion of the encryption key 1020 (or information for deriving the encryption key 1020). The processor 610, possibly in combination with the memory 630, possibly in combination with the transceiver 620 (e.g., the wireless transmitter 342 and the antenna 346 and/or the wireless transmitter 442 and the antenna 446 and/or the wired transmitter 452) may comprise means for transmitting the encryption message. The processor 510, possibly in combination with the memory 530, possibly in combination with the transceiver 520 (e.g., the wireless transmitter 242 and the antenna 246) may comprise means for transmitting the encryption message.

At stage 1320, the method 1300 includes transmitting, from the apparatus to at least the first UE and the second UE, a ranging indication indicating that the encryption input information is for producing an encrypted ranging signal for ranging. For example, the AD 1111, 1112 may indicate that the AD 1111, 1112 is for use in producing an STS for ranging. The processor 610, possibly in combination with the memory 630, possibly in combination with the transceiver 620 (e.g., the wireless transmitter 342 and the antenna 346 and/or the wireless transmitter 442 and the antenna 446 and/or the wired transmitter 452) may comprise means for transmitting the ranging indication. The processor 510, possibly in combination with the memory 530, possibly in combination with the transceiver 520 (e.g., the wireless transmitter 242 and the antenna 246) may comprise means for transmitting the ranging indication.

Implementations of the method 1300 may include one or more of the following features. In an example implementation, the apparatus is a third UE, and the ranging indication indicates that the encryption input information is for producing the encrypted ranging signal for ranging between the first UE and the second UE. For example, the UE 911 may be the AD source 1103 and the AD 1111 may indicate that the AD 1111 is for use in producing an STS for use in ranging with the second UE 1102 (e.g., information in the AD 1111 is based on communication of the UE 911 with the second UE 1102) and/or the AD 1112 may indicate that the AD 1112 is for use in producing an STS for use in ranging with the first UE 1101 (e.g., information in the AD 1112 is based on communication of the UE 911 with the first UE 1101). In another example implementation, the apparatus is a transmission/reception point, and transmitting the ranging indication comprises broadcasting the encryption message. For example, the AD source 1103 may be the TRP 600 and the AD 1111, 1112 may be network AD broadcast by the TRP 600 to the UEs 712, 713 (and to the UEs 711, 714-718). In another example implementation, the encryption input information comprises a plaintext portion, or a counter, or an encryption key, or any combination thereof.

### Implementation Examples

Implementation examples are provided in the following numbered clauses.
Clause 1. A first UE comprising:
   a transceiver configured to transmit and receive wireless signals;
   a memory; and
   a processor, communicatively coupled to the memory and the transceiver, configured to:
      receive, via the transceiver from a first entity, encryption input information;
      communicate, via the transceiver with a second entity that is a second UE, to establish a ranging session with the second UE;
      use the encryption input information to produce an encrypted ranging signal; and
      use the encrypted ranging signal in the ranging session for ranging between the first UE and the second UE.
Clause 2. The first UE of claim 1, wherein the encryption input information is first encryption input information, and wherein the processor is configured to:
   communicate, via the transceiver, with the second UE to agree to second encryption input information; and
   use the first encryption input information and the second encryption input information to produce the encrypted ranging signal.
Clause 3. The first UE of claim 2, wherein the second encryption input information comprises a first identity associated with the first entity, or a second identity associated with the second entity, or a third identity associated with the first UE, or any combination thereof.
Clause 4. The first UE of claim 2, wherein the second encryption input information comprises at least one key derivation function parameter, and wherein the processor is configured to use the at least one key derivation function parameter as part of a key derivation function to produce the encrypted ranging signal.
Clause 5. The first UE of claim 4, wherein the at least one key derivation function parameter comprises a random salt, or an indication of a proprietary key derivation function, or a combination thereof.
Clause 6. The first UE of claim 2, wherein at least some of the second encryption input information replaces at least some of the first encryption input information.
Clause 7. The first UE of claim 1, wherein the processor is configured to receive the encryption input information from a transmission/reception point in a broadcast message.
Clause 8. The first UE of claim 1, wherein the processor is configured to receive the encryption input information from a third UE in a positioning assistance message, and at least one of configured to produce the encrypted ranging signal based on the positioning assistance message identifying the second UE, or use the encrypted ranging signal in the ranging session based on the positioning assistance message identifying the second UE, or a combination thereof.
Clause 9. A ranging method comprising:
   receiving, at a first UE from a first entity, encryption input information;
   communicating, by the first UE with a second entity that is a second UE, to establish a ranging session with the second UE;
   using the encryption input information to produce an encrypted ranging signal; and
   using the encrypted ranging signal in the ranging session for ranging between the first UE and the second UE.
Clause 10. The ranging method of claim 9, wherein the encryption input information is first encryption input information, and wherein the ranging method further comprises:
   communicating by the first UE with the second UE to agree to second encryption input information; and
   using, at the first UE, the first encryption input information and the second encryption input information to produce the encrypted ranging signal.
Clause 11. The ranging method of claim 10, wherein the second encryption input information comprises a first identity associated with the first entity, or a second identity associated with the second entity, or a third identity associated with the first UE, or any combination thereof.
Clause 12. The ranging method of claim 10, wherein the second encryption input information comprises at least one key derivation function parameter, and wherein the ranging method further comprises using the at least one key derivation function parameter as part of a key derivation function to produce the encrypted ranging signal.
Clause 13. The ranging method of claim 12, wherein the at least one key derivation function parameter comprises a random salt, or an indication of a proprietary key derivation function, or a combination thereof.
Clause 14. The ranging method of claim 10, wherein at least some of the second encryption input information replaces at least some of the first encryption input information.
Clause 15. The ranging method of claim 9, further comprising receiving, at the first UE, the encryption input information from a transmission/reception point in a broadcast message.
Clause 16. The ranging method of claim 9, further comprising receiving, at the first UE, the encryption input information from a third UE in a positioning assistance message, and at least one of:
   producing the encrypted ranging signal based on the positioning assistance message identifying the second UE; or
   using the encrypted ranging signal in the ranging session based on the positioning assistance message identifying the second UE; or
   a combination thereof.
Clause 17. A first UE comprising:
   means for receiving, from a first entity, encryption input information;
   means for communicating, with a second entity that is a second UE, to establish a ranging session with the second UE;
   means for using the encryption input information to produce an encrypted ranging signal; and
   means for using the encrypted ranging signal in the ranging session for ranging between the first UE and the second UE.
Clause 18. The first UE of claim 17, wherein the encryption input information is first encryption input information, and wherein the first UE further comprises:
   means for communicating with the second UE to agree to second encryption input information; and
   means for using the first encryption input information and the second encryption input information to produce the encrypted ranging signal.
Clause 19. The first UE of claim 18, wherein the second encryption input information comprises a first identity associated with the first entity, or a second identity associated with the second entity, or a third identity associated with the first UE, or any combination thereof.
Clause 20. The first UE of claim 18, wherein the second encryption input information comprises at least one key derivation function parameter, and wherein the first UE further comprises means for using the at least one key derivation function parameter as part of a key derivation function to produce the encrypted ranging signal.
Clause 21. The first UE of claim 20, wherein the at least one key derivation function parameter comprises a random salt, or an indication of a proprietary key derivation function, or a combination thereof.
Clause 22. The first UE of claim 18, wherein at least some of the second encryption input information replaces at least some of the first encryption input information.
Clause 23. The first UE of claim 17, further comprising means for receiving the encryption input information from a transmission/reception point in a broadcast message.
Clause 24. The first UE of claim 17, further comprising:
   means for receiving the encryption input information from a third UE in a positioning assistance message; and
   at least one of:
      means for producing the encrypted ranging signal based on the positioning assistance message identifying the second UE; or
      means for using the encrypted ranging signal in the ranging session based on the positioning assistance message identifying the second UE; or
      a combination thereof.
Clause 25. A non-transitory, processor-readable storage medium comprising processor-readable instructions to cause a processor of a first UE to:
   receive, from a first entity, encryption input information;
   communicate, with a second entity that is a second UE, to establish a ranging session with the second UE;
   use the encryption input information to produce an encrypted ranging signal; and
   use the encrypted ranging signal in the ranging session for ranging between the first UE and the second UE.
Clause 26. The non-transitory, processor-readable storage medium of claim 25, wherein the encryption input information is first encryption input information, and wherein the non-transitory, processor-readable storage medium further comprises processor-readable instructions to cause the processor to:
   communicate with the second UE to agree to second encryption input information; and
   use the first encryption input information and the second encryption input information to produce the encrypted ranging signal.
Clause 27. The non-transitory, processor-readable storage medium of claim 26, wherein the second encryption input information comprises a first identity associated with the first entity, or a second identity associated with the second entity, or a third identity associated with the first UE, or any combination thereof.
Clause 28. The non-transitory, processor-readable storage medium of claim 26, wherein the second encryption input information comprises at least one key derivation function parameter, and wherein the non-transitory, processor-readable storage medium further comprises processor-readable instructions to cause the processor to use the at least one key derivation function parameter as part of a key derivation function to produce the encrypted ranging signal.
Clause 29. The non-transitory, processor-readable storage medium of claim 28, wherein the at least one key derivation function parameter comprises a random salt, or an indication of a proprietary key derivation function, or a combination thereof.
Clause 30. The non-transitory, processor-readable storage medium of claim 26, wherein at least some of the second encryption input information replaces at least some of the first encryption input information.
Clause 31. The non-transitory, processor-readable storage medium of claim 25, further comprising processor-readable instructions to cause the processor to receive the encryption input information from a transmission/reception point in a broadcast message.
Clause 32. The non-transitory, processor-readable storage medium of claim 25, further comprising:
   processor-readable instructions to cause the processor to receive the encryption input information from a third UE in a positioning assistance message; and
   at least one of:
   processor-readable instructions to cause the processor to produce the encrypted ranging signal based on the positioning assistance message identifying the second UE; or
   processor-readable instructions to cause the processor to use the encrypted ranging signal in the ranging session based on the positioning assistance message identifying the second UE; or
   a combination thereof.
Clause 33. An apparatus comprising:
   a transceiver configured to transmit and receive wireless signals;
   a memory; and
   a processor, communicatively coupled to the memory and the transceiver, configured to transmit, via the transceiver to at least a first UE and a second UE, an encryption message comprising encryption input information and a ranging indication indicating that the encryption input information is for producing an encrypted ranging signal for ranging.
Clause 34. The apparatus of claim 33, wherein the apparatus is a third UE, and wherein the ranging indication indicates that the encryption input information is for producing the encrypted ranging signal for ranging between the first UE and the second UE.
Clause 35. The apparatus of claim 33, wherein the apparatus is a transmission/reception point, and wherein the processor is configured to transmit the ranging indication by having the transceiver broadcast the encryption message.
Clause 36. The apparatus of claim 33, wherein the encryption input information comprises a plaintext portion, or a counter, or an encryption key, or any combination thereof.
Clause 37. A ranging information distribution method comprising:
   transmitting, from an apparatus to at least a first UE and a second UE, an encryption message comprising encryption input information; and
   transmitting, from the apparatus to at least the first UE and the second UE, a ranging indication indicating that the encryption input information is for producing an encrypted ranging signal for ranging.
Clause 38. The ranging information distribution method of claim 37, wherein the apparatus is a third UE, and wherein the ranging indication indicates that the encryption input information is for producing the encrypted ranging signal for ranging between the first UE and the second UE.
Clause 39. The ranging information distribution method of claim 37, wherein the apparatus is a transmission/reception point, and wherein transmitting the ranging indication comprises broadcasting the encryption message.
Clause 40. The ranging information distribution method of claim 37, wherein the encryption input information comprises a plaintext portion, or a counter, or an encryption key, or any combination thereof.
Clause 41. An apparatus comprising:
   means for transmitting, to at least a first UE and a second UE, an encryption message comprising encryption input information; and
   means for transmitting, to at least the first UE and the second UE, a ranging indication indicating that the encryption input information is for producing an encrypted ranging signal for ranging.
Clause 42. The apparatus of claim 41, wherein the apparatus is a third UE, and wherein the ranging indication indicates that the encryption input information is for producing the encrypted ranging signal for ranging between the first UE and the second UE.
Clause 43. The apparatus of claim 41, wherein the apparatus is a transmission/reception point, and wherein the means for transmitting the ranging indication comprise means for broadcasting the encryption message.
Clause 44. The apparatus of claim 41, wherein the encryption input information comprises a plaintext portion, or a counter, or an encryption key, or any combination thereof.
Clause 45. A non-transitory, processor-readable storage medium comprising processor-readable instructions to cause a processor of an apparatus to:
   transmit, to at least a first UE and a second UE, an encryption message comprising encryption input information; and
   transmit, to at least the first UE and the second UE, a ranging indication indicating that the encryption input information is for producing an encrypted ranging signal for ranging.
Clause 46. The non-transitory, processor-readable storage medium of claim 45, wherein the apparatus is a third UE, and wherein the ranging indication indicates that the encryption input information is for producing the encrypted ranging signal for ranging between the first UE and the second UE.
Clause 47. The non-transitory, processor-readable storage medium of claim 45, wherein the apparatus is a transmission/reception point, and wherein the processor-readable instructions to cause the processor to transmit the ranging indication comprise processor-readable instructions to cause the processor to broadcast the encryption message.
Clause 48. The non-transitory, processor-readable storage medium of claim 45, wherein the encryption input information comprises a plaintext portion, or a counter, or an encryption key, or any combination thereof.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of” or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that communication using the wireless communication device is exclusively, or evenly primarily, wireless, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

Unless otherwise indicated, “about” and/or “approximately” as used herein when referring to a measurable value such as an amount, a temporal duration, and the like, encompasses variations of ±20% or ±10%, ±5%, or +0.1% from the specified value, as appropriate in the context of the systems, devices, circuits, methods, and other implementations described herein. Unless otherwise indicated, “substantially” as used herein when referring to a measurable value such as an amount, a temporal duration, a physical attribute (such as frequency), and the like, also encompasses variations of ±20% or ±10%, ±5%, or +0.1% from the specified value, as appropriate in the context of the systems, devices, circuits, methods, and other implementations described herein.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A first UE (user equipment) comprising:
a transceiver configured to transmit and receive wireless signals;
a memory; and
a processor, communicatively coupled to the memory and the transceiver, configured to:
receive, via the transceiver from a first entity, encryption input information;
communicate, via the transceiver with a second entity that is a second UE, to establish a ranging session with the second UE;
use the encryption input information to produce an encrypted ranging signal; and
use the encrypted ranging signal in the ranging session for ranging between the first UE and the second UE.

2. The first UE of claim 1, wherein the encryption input information is first encryption input information, and wherein the processor is configured to:
communicate, via the transceiver, with the second UE to agree to second encryption input information; and
use the first encryption input information and the second encryption input information to produce the encrypted ranging signal.

3. The first UE of claim 2, wherein the second encryption input information comprises a first identity associated with the first entity, or a second identity associated with the second entity, or a third identity associated with the first UE, or any combination thereof.

4. The first UE of claim 2, wherein the second encryption input information comprises at least one key derivation function parameter, and wherein the processor is configured to use the at least one key derivation function parameter as part of a key derivation function to produce the encrypted ranging signal.

5. The first UE of claim 4, wherein the at least one key derivation function parameter comprises a random salt, or an indication of a proprietary key derivation function, or a combination thereof.

6. The first UE of claim 2, wherein at least some of the second encryption input information replaces at least some of the first encryption input information.

7. The first UE of claim 1, wherein the processor is configured to receive the encryption input information from a transmission/reception point in a broadcast message.

8. The first UE of claim 1, wherein the processor is configured to receive the encryption input information from a third UE in a positioning assistance message, and at least one of configured to produce the encrypted ranging signal based on the positioning assistance message identifying the second UE, or use the encrypted ranging signal in the ranging session based on the positioning assistance message identifying the second UE, or a combination thereof.

9. A ranging method comprising:
receiving, at a first UE (user equipment) from a first entity, encryption input information;
communicating, by the first UE with a second entity that is a second UE, to establish a ranging session with the second UE;
using the encryption input information to produce an encrypted ranging signal; and
using the encrypted ranging signal in the ranging session for ranging between the first UE and the second UE.

10. The ranging method of claim 9, wherein the encryption input information is first encryption input information, and wherein the ranging method further comprises:
communicating by the first UE with the second UE to agree to second encryption input information; and
using, at the first UE, the first encryption input information and the second encryption input information to produce the encrypted ranging signal.

11. The ranging method of claim 10, wherein the second encryption input information comprises a first identity associated with the first entity, or a second identity associated with the second entity, or a third identity associated with the first UE, or any combination thereof.

12. The ranging method of claim 10, wherein the second encryption input information comprises at least one key derivation function parameter, and wherein the ranging method further comprises using the at least one key derivation function parameter as part of a key derivation function to produce the encrypted ranging signal.

13. The ranging method of claim 12, wherein the at least one key derivation function parameter comprises a random salt, or an indication of a proprietary key derivation function, or a combination thereof.

14. The ranging method of claim 10, wherein at least some of the second encryption input information replaces at least some of the first encryption input information.

15. The ranging method of claim 9, further comprising receiving, at the first UE, the encryption input information from a transmission/reception point in a broadcast message.

16. The ranging method of claim 9, further comprising receiving, at the first UE, the encryption input information from a third UE in a positioning assistance message, and at least one of:
producing the encrypted ranging signal based on the positioning assistance message identifying the second UE; or
using the encrypted ranging signal in the ranging session based on the positioning assistance message identifying the second UE; or
a combination thereof.

17. A first UE (user equipment) comprising:
means for receiving, from a first entity, encryption input information;
means for communicating, with a second entity that is a second UE, to establish a ranging session with the second UE;
means for using the encryption input information to produce an encrypted ranging signal; and
means for using the encrypted ranging signal in the ranging session for ranging between the first UE and the second UE.

18. The first UE of claim 17, wherein the encryption input information is first encryption input information, and wherein the first UE further comprises:
means for communicating with the second UE to agree to second encryption input information; and
means for using the first encryption input information and the second encryption input information to produce the encrypted ranging signal.

19. The first UE of claim 18, wherein the second encryption input information comprises a first identity associated with the first entity, or a second identity associated with the second entity, or a third identity associated with the first UE, or any combination thereof.

20. The first UE of claim 18, wherein the second encryption input information comprises at least one key derivation function parameter, and wherein the first UE further comprises means for using the at least one key derivation function parameter as part of a key derivation function to produce the encrypted ranging signal.

21. The first UE of claim 20, wherein the at least one key derivation function parameter comprises a random salt, or an indication of a proprietary key derivation function, or a combination thereof.

22. The first UE of claim 18, wherein at least some of the second encryption input information replaces at least some of the first encryption input information.

23. The first UE of claim 17, further comprising means for receiving the encryption input information from a transmission/reception point in a broadcast message.

24. The first UE of claim 17, further comprising:
means for receiving the encryption input information from a third UE in a positioning assistance message; and
at least one of:
means for producing the encrypted ranging signal based on the positioning assistance message identifying the second UE; or
means for using the encrypted ranging signal in the ranging session based on the positioning assistance message identifying the second UE; or
a combination thereof.

25. A non-transitory, processor-readable storage medium comprising processor-readable instructions to cause a processor of a first UE (user equipment) to:
receive, from a first entity, encryption input information;
communicate, with a second entity that is a second UE, to establish a ranging session with the second UE;
use the encryption input information to produce an encrypted ranging signal; and
use the encrypted ranging signal in the ranging session for ranging between the first UE and the second UE.

26. The non-transitory, processor-readable storage medium of claim 25, wherein the encryption input information is first encryption input information, and wherein the non-transitory, processor-readable storage medium further comprises processor-readable instructions to cause the processor to:
communicate with the second UE to agree to second encryption input information; and
use the first encryption input information and the second encryption input information to produce the encrypted ranging signal.

27. The non-transitory, processor-readable storage medium of claim 26, wherein the second encryption input information comprises a first identity associated with the first entity, or a second identity associated with the second entity, or a third identity associated with the first UE, or any combination thereof.

28. The non-transitory, processor-readable storage medium of claim 26, wherein the second encryption input information comprises at least one key derivation function parameter, and wherein the non-transitory, processor-readable storage medium further comprises processor-readable instructions to cause the processor to use the at least one key derivation function parameter as part of a key derivation function to produce the encrypted ranging signal.

29. The non-transitory, processor-readable storage medium of claim 28, wherein the at least one key derivation function parameter comprises a random salt, or an indication of a proprietary key derivation function, or a combination thereof.

30. The non-transitory, processor-readable storage medium of claim 26, wherein at least some of the second encryption input information replaces at least some of the first encryption input information.
